(19) United States
(12) Patent Application Publication
(10) Pub. No.: US 2008/0148915 A1
(43) Pub. Date: Jun. 26, 2008

(54) POWER TOOLS

(75) Inventors: Richard C. Nickels, Hampstead, MD (US); Michael I. McDowell, Baltimore, MD (US); David L. Wikle, York, PA (US); Tim J. Bowman, Essex, MD (US)

Correspondence Address: HARNESS, DICKEY & PIERCE, P.L.C., P.O. BOX 828, BLOOMFIELD HILLS, MI, 48303, US

(73) Assignee: Black & Decker Inc., Newark, DE (US)

(21) Appl. No.: 11/860,989

(22) Filed: Sep. 25, 2007

Related U.S. Application Data
(60) Provisional application No. 60/863,467, filed on Oct. 30, 2006.

(51) Int. Cl. B23D 45/00

(52) U.S. Cl. 83/469; 83/471.2

(57) ABSTRACT

A power tool is provided with a hanger having multiple discrete width positions to engage materials of different thicknesses. The power cord is installed in the tool housing with an extra length of cable between the cord clamp and the portion of the tool housing that secures the cord protector. A crimp-on device is installed on the power cord cable next to the cord protector. When the cord is subjected to jerking, the cable moves axially relative to the cord protector. As the cable moves, the crimp-on device compresses the extended end of the cord protector absorbing energy and reducing the forces transmitted to the cord set conductors. A rip guide includes a long guide edge and two attachment points to the shoe/base of the saw. The rip guide is attached to the base/shoe via a pair of L-shaped openings that accept L-shaped support arms of the rip guide.

### CROSS-REFERENCE TO RELATED APPLICATIONS

This application claims the benefit of U.S. Provisional Application No. 60/863,467 filed on Oct. 30, 2006, the disclosure of which is incorporated herein by reference.

### FIELD

The present disclosure relates to various improvements for power tools, and particularly to a tool hanger, a cord set load protector, and a saw rip guide.

### BACKGROUND AND SUMMARY

The statements in this section merely provide background information related to the present disclosure and may not constitute prior art.

Portable tools are often equipped with tool hangers. The tool hangers allow the user to place the tool down over a structural member in a convenient location when the tool is not in use. These hangers may be integrated into the design of the tool, or may be bolt-on aftermarket accessories. The present disclosure is directed to a tool hanger that is pivotable between a use position and a non-use position. The hanger is designed to have a wider opening to accept various sized materials. For example, the wide tool hanger will accept 2× thickness framing lumber, engineered wood products, such as LVL and build-up sections, such as MacMillan Truss-Joists™, both of which are thicker than the 2× framing lumber.

Preferably, the wider hanger has two or more discrete width positions to securely engage the material. It may also have a tapered section between the widest and narrowest width positions to allow use with materials of intermediate thicknesses.

According to another aspect of the present invention, a common field failure with heavier portable power tools, such as portable saws, is a separation of the power cord from the tool due to an impulse load, or jerk, applied to the cord. This can occur when the tool is dropped while the plug end of the power cord is secured, or when a user carries the tool or lowers it from floor to floor or down a ladder by holding the power cord.

To isolate the power cord conductors or connections from the high forces imposed by jerking the power cord, the power cord according to the present disclosure is installed in the tool housing with a small service loop, or extra length of cable, between the cord clamp and the portion of the tool housing that secures the cord protector. A crimp-on device is installed on the power cord cable next to the cord protector. When the cord is subjected to jerking, the cable moves axially relative to the cord protector. As the cable moves, the crimp-on device compresses the extended end of the cord protector absorbing energy and reducing the forces transmitted to the cord set conductors or connections that are disposed within the housing.

According to yet another aspect of the present disclosure, rip guides are used as an accessory with portable saws to assist the user in making accurate rip cuts on a work piece. The present disclosure includes a rip guide having a long guide edge and two attachment points to the shoe/base of the saw. The rip guide accessory is attached to the base/shoe via a pair of L-shaped openings. The L-shaped openings are versatile in that they are compatible with existing rip guides and they accept the L-shaped support arms of the rip guide of the present disclosure. The L-shaped geometry provides a significant improvement in durability of the rip guide. The support arms can be fixed to the guide edge using a pivot connection, such as by rivets, to be folded to a more compact size for storage. Another alternate design allows the rip guide to be folded using a two-piece guide edge connected by a link with pivot connections.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an exemplary worm drive saw with a tool hanger according to the principles of the present disclosure;

FIG. 2 is a top view of the exemplary saw being hung by the hanger on a joist;

FIG. 3 is an end view of the saw shown in FIG. 2 hanging from a joist;

FIG. 4 is a plan view of an exemplary hanger configuration according to the principles of the present disclosure;

FIG. 5 is an alternate configuration of the tool hanger according to the principles of the present disclosure;

FIG. 6a is a cross-sectional view of an exemplary 2× joist;

FIG. 6b is a cross-sectional view of an exemplary engineered joist;

FIG. 6c is a cross-sectional view of still another exemplary truss-joist;

FIG. 7 is a cross-sectional view showing the cord set load protector according to the principles of the present disclosure, in an unloaded condition;

FIG. 8 is a view similar to FIG. 7 with a load applied to the cord;

FIG. 9 is a perspective view of an exemplary cord clamp utilized with the cord set load protector according to the principles of the present disclosure;

FIG. 10 is a perspective view of a first clamp half;

FIG. 11 is a perspective view of a second clamp half;

FIG. 12 is a perspective view of an alternative cord set load protector design with the handle partially removed for illustrative purposes;

FIG. 13 is a perspective view of an exemplary saw and rip guide according to the principles of the present disclosure;

FIG. 14 is a perspective view of a saw and alternative embodiment of the rip guide according to the principles of the present disclosure;

FIG. 15 is a perspective view of the saw shown in FIG. 13 with the rip guide removed;

FIG. 16 is a close-up plan view illustrating the L-shaped channels provided in the saw shoe for receipt of an L-shaped or flat support arm of a rip guide;

FIG. 17 is a perspective view of an exemplary rip guide illustrating the use of a pivot connection between the guide edge and support arms;

FIG. 18 is a perspective view of a still further exemplary rip guide having a two-piece guide edge connected by a link with pivot connections according to the principles of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

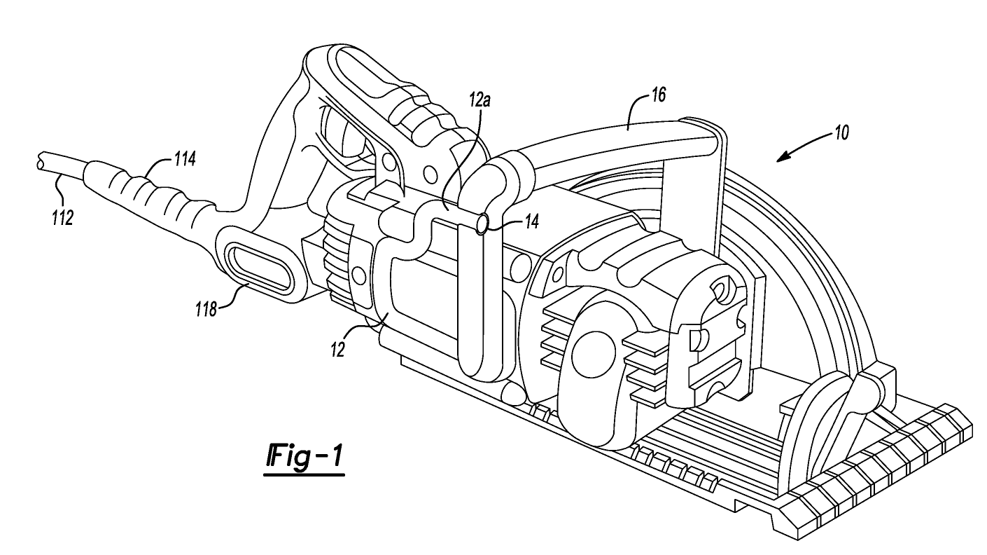

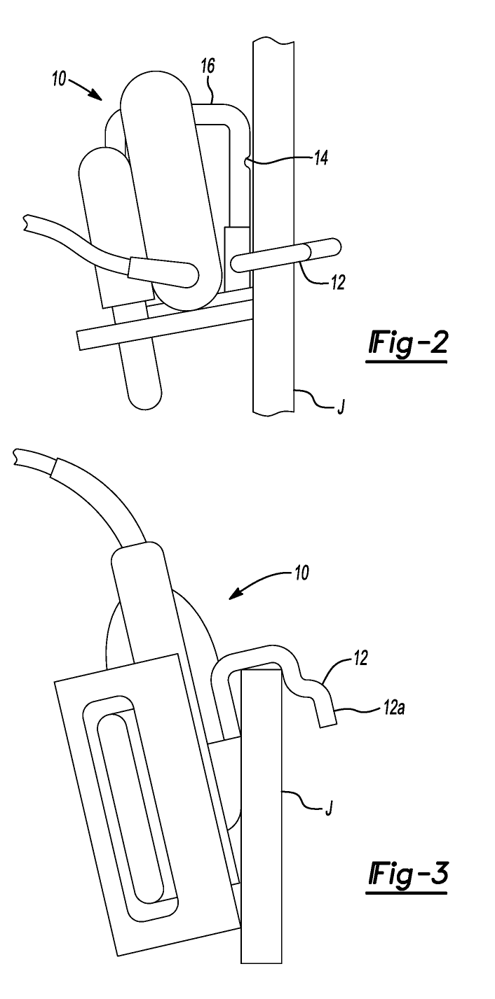

With reference to FIG. 1, an exemplary power tool 10 is shown including a hanger 12 pivotally attached to the tool to allow the hanger to be moved between a use position and a non-use position. As illustrated in FIG. 1, the hanger 12 is provided in the non-use position in which an end portion 12a is received in a recess 14 provided in the handle 16. FIGS. 2 and 3 illustrate the hanger 12 in the use-position, both in a top view (FIG. 2) and an end view (FIG. 3) with the hanger 12 engaging a joist (J).

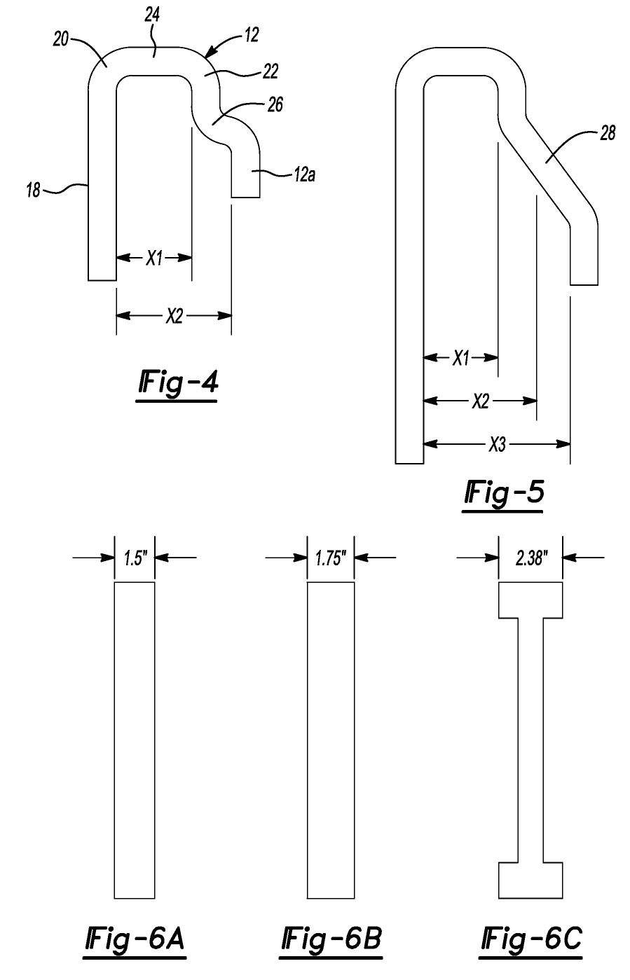

As shown in FIG. 4, the hanger 12 includes a support arm 18 which is pivotally connected to the body of the saw 10. A first generally 90° bend portion 20 and a second generally 90° bend portion 22 define a U-shaped hook portion 24 defining a space therebetween having a dimension X1 preferably designed to receive 2× thickness framing lumber. The hanger 12 is designed to have a step portion 26 that terminates in the end portion 12a of the hanger 12. The step portion provides a wider opening preferably having a dimension X2 which is sized to accept larger thickness wood products such as engineered joists and Truss-Joists™, both of which are thicker than the 2× framing lumber.

By way of example, as illustrated in FIGS. 6a-6c, the 2× lumber shown in FIG. 6a has a thickness of 1.5 inches, while the LVL engineering joist, as shown in FIG. 6b, has a thickness of 1.75 inches, and the typical MacMillan Truss-Joist™ can have a thickness of 2.38 inches, as illustrated in FIG. 6c. With the tool hanger 12, according to the principles of the present disclosure, the tool hanger is capable of accepting various sized materials for securely hanging the power tool 10 thereon. The hanger 12 is illustrated as having a single stepped portion 26, though it should be understood that multiple step portions can be utilized in order to accommodate three or more discrete width positions. Alternatively, as illustrated in FIG. 5, the hanger can be provided with a sloped section 28 in order to accommodate various intermediate sized framing lumber. The slope section 28 would wedge against the outer edge of the intermediate sized lumber in order to securely support the power tool 10 thereon.

With reference to FIG. 7, a cord set load protector device 110 is shown for preventing high forces imposed on a power cord 112 from impacting the connections of the cord 112 to the electrical power tool 10. As illustrated in FIG. 1, the power tool 10 includes a cord 112 and a cord protector 114 extending from the rear end of the tool. The cord protector 114 is mounted within a recess 116 provided in the power tool housing 118. The recess 116 can be square or round in cross-section and defines a cavity therein for receiving a radially extending flange portion 120 of the elastomeric cord protector 114. The radial extending flange portion 120 is disposed against a shoulder portion 122. A crimp-on device 124 is clamped or crimped onto the power cord 112 and includes a radially extending flange portion 126 which is disposed against an end portion of the cord protector 114 inside of the chamber 116 of housing 118. The flange portion 126 is disposed against a radially inwardly extending shoulder 128 of the cavity 116 provided in the housing 118.

The crimp-on device 124 engages the power cord so as to be axially and rotatably fixed to the power cord 112 in a manner that will be described in greater detail herein. The power cord 112 is also clamped to the tool housing by a cord clamp 130 provided within the power tool 10 in such a way that an extra cable length 112a is provided within the housing between the crimp-on device 124 and cord clamp 130. The cord clamp 130 can be mounted to the housing by fasteners 132 or by other known securing methods, such as rivets, welds, grommets, etc. The cord clamp 130 can be spaced from the recess 116 by up to several inches. Locating the cord clamp 130 further inward from the recess 116 improves cord flex durability by placing the cord stresses from the cord being flexed and the stresses on the cord due to the clamp at two different locations instead of both being generally at the same location. This improves the flex life of the conductors.

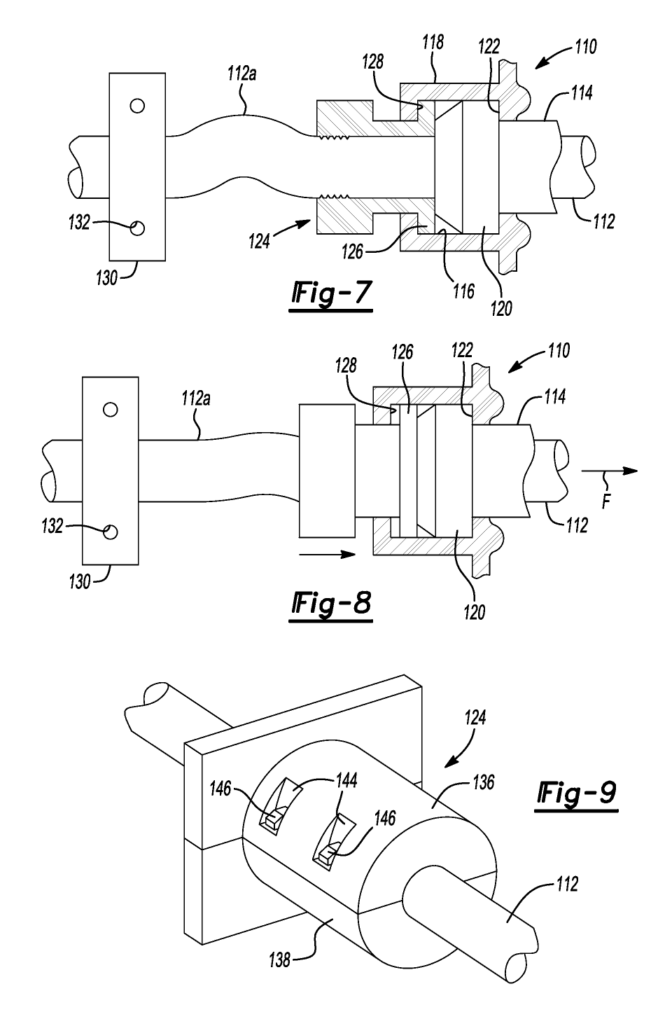

When a large force F is applied to the power cord 112, as illustrated in FIG. 8, the power cord 112 is pulled in the axial direction of the force F. The movement of the power cord 112 relative to the housing 118 causes the crimp-on device 124 to move axially relative to the shoulder portion 128 so that the flange portion 126 of crimp-on device 124 compresses the flange portion 120 of cord protector 114, thereby absorbing the force exerted on the cord 112. The axial movement of the crimp-on device relative to the cord clamp 130 takes up some of the extra cable length 112a provided therebetween without exerting forces upon the cord clamp 130.

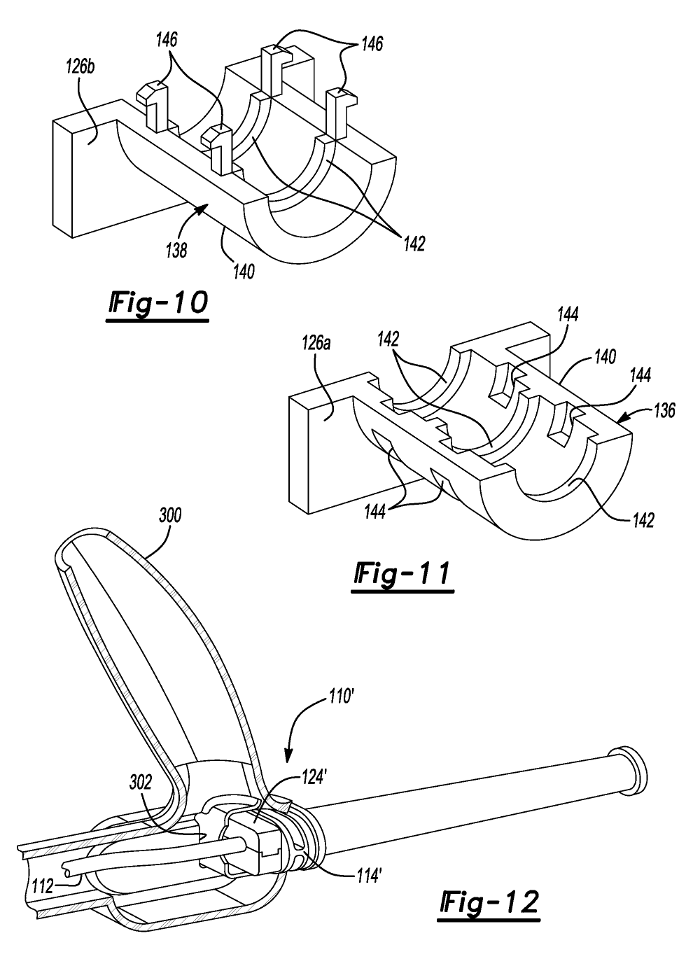

The crimp-on device 124 can take-on many forms. By way of example, as illustrated in FIGS. 9 and 11, the crimp-on device 124 can include a first clamp half 136 and a second clamp half 138. Each clamp half 136, 138 is provided with semi-cylindrical body portions 140 each provided with a plurality of radially inwardly extending ribs 142 designed to engage and clamp against the outer surface of the power cord 112. The first clamp half 136 is provided with a plurality of apertures 144 each adapted to receive a plurality of corresponding locking fingers 146 provided on the second clamp half 138. Each of the first and second clamp halves 136, 138 include radial flange portions 126a, 126b, respectively, which define the radially extending flange portion 126 of the crimp-on device 124. The locking fingers 146 secure the second clamp half 138 to the first clamp half 136 in a clamping engagement on the power cord 112 so as to prevent axial or rotational movement of the power cord 112 relative to the clamp device 124. It should be understood that other clamp or crimp-on arrangements can be utilized with the cord-set load protector 110, according to the principles of the present disclosure.

With reference to FIG. 12, an alternative cord set load protector 110′ is shown including a split clamp device 124′ received in a recess 302 within the handle section 300 to prevent the assembly from twisting or being pushed into the handle set. The split clamp 124′ is independent of the handle set 300 and traps the complete cord set 112 and secondary wrap of filler strands. The cord protector 114′ includes added material at the mounting end that prevents twist and creates a spring to absorb shock.

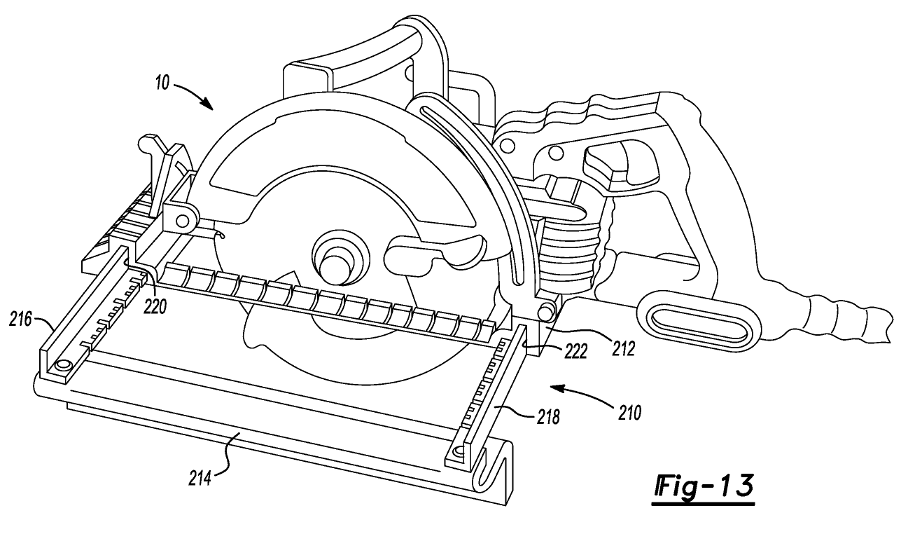

With reference to FIG. 13, the saw 10, according to the principles of the present disclosure is shown provided with a rip guide 210 adjustably mounted to the saw shoe 212. The rip guide 210 includes an elongated guide edge 214 supported by a pair of support arms 216, 218. The support arms 216, 218 are provided with an L-shaped cross-section and are received in L-shaped openings 220, 222 provided in the saw shoe 212. The L-shaped cross-section of the support arms 216, 218 provides a significant improvement in durability of the rip guide 210 by providing added structural strength thereto. The L-shaped support arms 216, 218 also improve piloting and stability of the rip guide with respect to the saw shoe 212. Alternatively, other shaped support arms such as a T-shaped, I-shaped, C-shaped, vertical flat, or horizontal flat cross-section can also be used. The interface between the openings 220, 222 and the support arms can have a “keyed” interface wherein the interface has a horizontal pattern and a vertical pattern. The corresponding L-shaped, T-shaped, I-shaped, and C-shaped openings 220, 222 provided in the saw shoe 212 also accommodate the flat cross-section support arms 230 (see FIG. 5) that have been used with conventional rip guides.

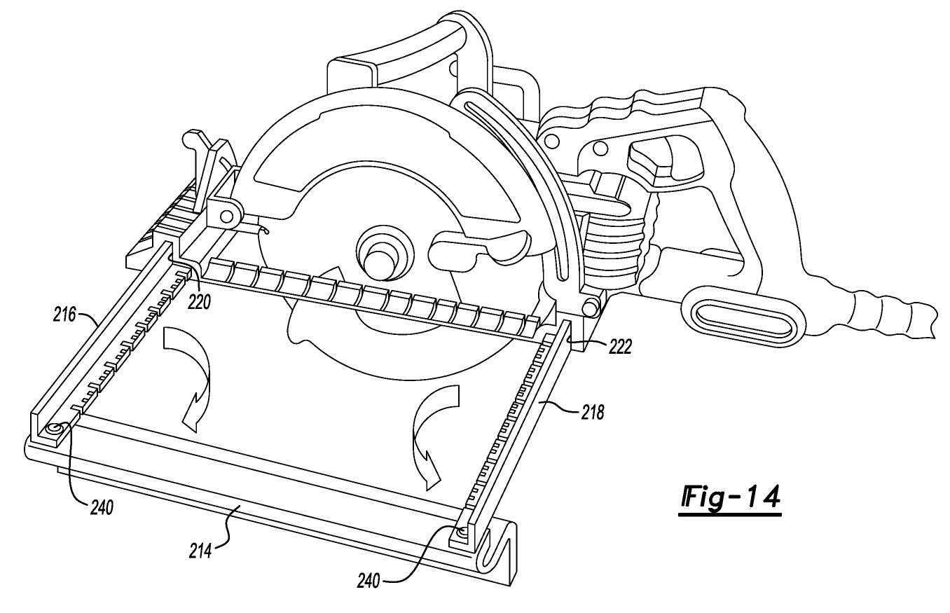

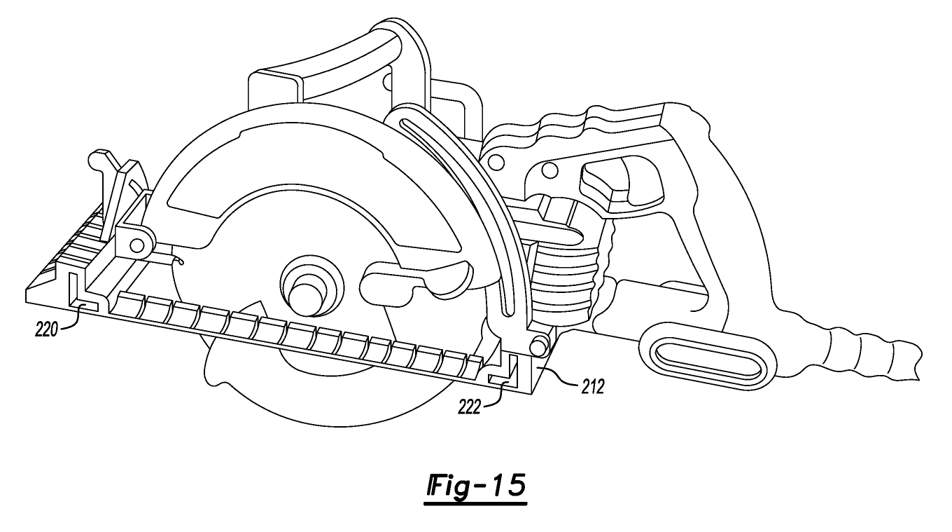

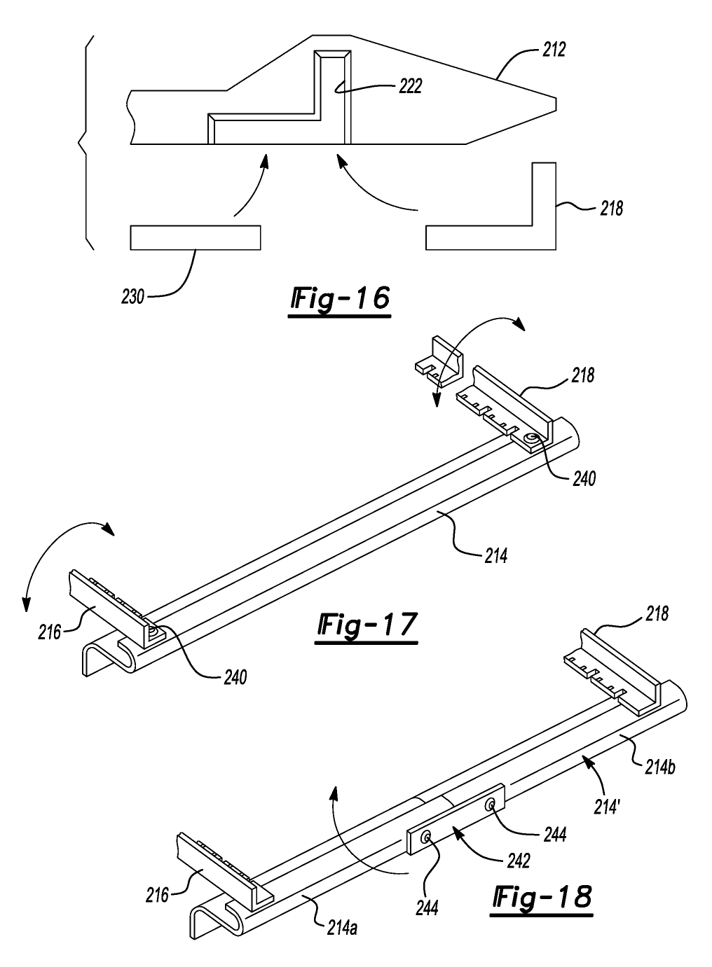

As illustrated in FIG. 13, the support arms 216, 218 can be fixedly connected to the guide edge 214 such as by soldering, welding, or other known fastening techniques. Alternatively, as shown in FIG. 14, the support arms 216, 218 can be connected to the guide edge 214 by pivot connections 240 such as by rivets or other pivot fasteners which allow the support arms to be folded relative to the guide edge 214 for more compact storage.

According to another alternative, as illustrated in FIG. 18, the support arms 216, 218 can be connected to a two-piece guide edge 214′ including a first guide edge 214a and second guide edge 214b which are connected by a link 242 that is pivotally connected to each of the guide edge portions 214a, 214b to allow the guide edge 214′ to be folded generally in half for compact storage.

1. A power saw, comprising:
a saw body including a motor casing and a handle connected to said motor casing;
a motor disposed in said motor casing;
a saw blade drivingly connected to said motor; and
a hanger pivotally connected to said saw body for movement between a stowed position and a hanging position, adapted for hanging said power saw.

2. The power saw according to claim 1, wherein said hanger includes a support arm pivotally connected to said saw body and first and second bend portions defining a U-shaped hook portion defining a space therebetween having a first dimension, said hanger including a step portion that terminates in an end of said hanger, said step portion defining a space between said step portion and said support arm having a second dimension larger than said first dimension.

3. The power saw according to claim 2, further comprising a sloped section extending from said U-shaped hook portion to said step portion.

4. The power saw according to claim 1, wherein said saw blade is a circular saw blade.

5. A power saw, comprising:
a saw body including a motor casing and a handle connected to said motor casing;
a motor disposed in said motor casing;
a saw blade drivingly connected to said motor; and
a hanger connected to said saw body, wherein said hanger includes a support arm pivotally connected to said saw body and first and second bend portions defining a U-shaped hook portion defining a space therebetween having a first dimension, said hanger including a step portion that terminates in an end of said hanger, said step portion defining a space between said step portion and said support arm having a second dimension larger than said first dimension.

6. The power saw according to claim 5, further comprising a sloped section extending from said U-shaped hook portion to said step portion.

7. The power saw according to claim 5, wherein said saw blade is a circular saw blade.

8. A power tool, comprising:
a tool body including a motor casing and a handle connected to said motor casing, said tool body defining a recess;
a motor disposed in said motor casing;
a power cord connected to said motor;
an elastomeric cord protector mounted on said power cord and including a first radially extending flange portion received in said recess;
a crimp-on device mounted to said power cord and including a second radially extending flange portion received in said recess and disposed against an end of said elastomeric cord protector.

9. The power tool according to claim 8, further comprising a cord clamp mounted to said tool body and clamping said power cord therebetween, wherein said power cord has slack between said cord clamp and said crimp-on device.

10. The power cord according to claim 8, wherein said crimp-on device is a split clamp device.

11. A circular saw, comprising:
a tool body including a motor casing and a handle connected to said motor casing;
a motor disposed in said motor casing;
a circular saw blade drivingly connected to said motor;
a saw shoe mounted to said tool body, said saw shoe defining a pair of openings in a side thereof; and
a rip guide removably mounted to said openings in said saw shoe, said rip guide including an elongated guide edge supported by a pair of spaced support arms received in said pair of openings in said saw shoe.

12. The circular saw according to claim 11, wherein said pair of support arms have an L-shaped cross-section.

13. The circular saw according to claim 11, wherein said pair of support arms are pivotally mounted to said elongated guide edge.

14. The circular saw according to claim 11, wherein said at least one of said pair of support arms includes a measurement scale thereon.

15. The circular saw according to claim 11, wherein said edge guide includes first and second guide edges connected by a link pivotally connected to said first and second guide edges.

16. The circular saw according to claim 11, wherein said openings in said saw shoe have an L-shaped cross-section.

17. The circular saw according to claim 11, wherein said openings in said saw shoe and said pair of support arms have a keyed interface with a horizontal and a vertical pattern.

18. The power saw according to claim 1, wherein said hanger includes a support arm pivotally connected to said saw body and first and second bend portions defining a U-shaped hook portion defining a space therebetween having a first dimension, said hanger including a sloped section extending from said U-shaped hook portion to an end of said hanger, said sloped portion defining a space between said sloped section and said support arm having a second dimension larger than said first dimension.

19. A power saw, comprising:
a saw body including a motor casing and a handle connected to said motor casing;
a motor disposed in said motor casing;
a saw blade drivingly connected to said motor; and
a hanger connected to said saw body, said hanger includes a support arm connected to said saw body and first and second bend portions defining a U-shaped hook portion and a first engagement dimension, said hanger further shaped to define a second engagement dimension, said second engagement dimension being larger than said first engagement dimension.

20. The power saw according to claim 19, wherein said hanger is further shaped to define a third engagement dimension, said third engagement dimension being larger than said first engagement dimension and smaller than said second engagement dimension.

21. The power saw according to claim 20, further comprising a sloped portion formed in said hanger and being disposed between said U-shaped hook portion and an end of said hanger, said sloped portion and said support arm defining at least one of said second engagement dimension and said third engagement dimension.

22. The power saw according to claim 19, further comprising a step portion formed in said hanger and being disposed between said U-shaped hook portion and an end of said hanger, said step portion and said support arm defining said second engagement dimension.

23. The power saw according to claim 19, wherein said saw blade is a circular saw blade.
